(19) United States
(12) Patent Application Publication
(10) Pub. No.: US 2007/0238517 A1
(43) Pub. Date: Oct. 11, 2007

(54) Gaming machine

(75) Inventor: Akira Osawa, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 11/730,251

(22) Filed: Mar. 30, 2007

(30) Foreign Application Priority Data
Apr. 5, 2006 (JP) JP2006-104405

(51) Int. Cl. A63F 13/00

(52) U.S. Cl. 463/20

(57) ABSTRACT

A gaming machine comprising: a base bet setting device for setting a bet number for a game; a display device for displaying a plurality of symbols; a special bet device for setting odds for a winning combination of symbols; an odds display device for displaying odds for a plurality of winning combinations, respectively; and a processor for controlling the game is provided. The processor is operable to: calculate a payout amount by multiplying a payout rate with the bet number set by the base bet setting device when any one of the plurality of winning combinations of symbols is displayed; calculate a total payout amount by multiplying the payout amount with the odds set by the special bet device; and pay out the total payout amount.

### CROSS REFERENCE TO RELATED APPLICATIONS

This application is based upon and claims the benefits of priority from Japanese Patent Application No. 2006-104405 filed on Apr. 5, 2006, the entire contents of which are incorporated herein by reference.

### FIELD OF THE INVENTION

The present invention relates to a gaming machine, in which payout is conducted based on a combination of displayed symbols.

### RELATED ART

Conventionally, a gamine machine of this type is a slot machine disclosed, for example, in Japanese Unexamined Patent Application Publication No. 2003-19242. The disclosed slot machine provides a payout amount corresponding to a combination of symbols displayed along the pay line as a plurality of symbol arrays composed of a plurality of symbols are rotated and stopped.

In this regards, a high payout rate is set to the combination of symbols with a low realization probability while a low payout rate is set to the combination of symbols with a high realization probability. Therefore, in order to obtain a large payout amount at once, it is necessary to let the slot machine display the combination of symbols with the low realization probability along the pay line such that the slot machine may tend to provide a game player with a rather negative impression that it is quite rare to obtain a large payout amount.

### SUMMARY OF THE INVENTION

In the present invention, a gaming machine comprising: a base bet setting device for setting a bet number for a game; a display device for displaying a plurality of symbols; a special bet device for setting odds for a winning combination of symbols; an odds display device for displaying odds for a plurality of winning combinations, respectively; and a processor for controlling the game is provided. The processor is operable to: calculate a payout amount by multiplying a payout rate with the bet number set by the base bet setting device when any one of the plurality of winning combinations of symbols is displayed; calculate a total payout amount by multiplying the payout amount with the odds set by the special bet device; and pay out the total payout amount.

Further features of the present invention, its nature, and various advantages will be more apparent from the accompanying drawings and the following description of the preferred embodiment.

### BRIEF DESCRIPTION OF THE DRAWINGS

FIG. 1 is a perspective drawing showing an outer shape of a slot machine relating to the present embodiment.

FIG. 2 shows a schematic diagram of arrays of symbols depicted on the outer periphery of each video reel.

FIG. 3 is a block diagram showing schematically a control system of the slot machine relating to the present embodiment.

FIG. 4 is a drawing showing a payout table about winning combinations, realization probabilities thereof and payout rates thereof of the slot machine relating to the present embodiment.

FIG. 5 is a drawing showing one example of images displayed on the lower image display panel.

FIG. 6 is a drawing showing another example of images displayed on the lower image display panel.

FIG. 7 is a drawing showing an odds table indicating winning combinations, initial odds values, numbers of times of consecutive failures, and current odds values of the slot machine relating to the present embodiment.

FIG. 8 is a drawing showing an odds table indicating winning combinations, initial odds values, numbers of times of consecutive failures, and current odds values of the slot machine relating to the present embodiment.

FIG. 9 is a drawing showing an odds table indicating winning combinations, initial odds values, numbers of times of consecutive failures, and current odds values of the slot machine relating to the present embodiment.

FIG. 10 is a drawing showing an odds table indicating winning combinations, initial odds values, numbers of times of consecutive failures, and current odds values of the slot machine relating to the present embodiment.

FIG. 11 is a drawing showing one example of payout table displayed on the upper image display panel.

FIG. 12 is a drawing showing one example of payout table displayed on the upper image display panel.

FIG. 13 is a drawing showing one example of payout table displayed on the upper image display panel.

FIG. 14 shows a flow chart of a main control process program of the slot machine relating to the present embodiment.

FIG. 15 shows a flow chart of a main control process program of the slot machine relating to the present embodiment.

FIG. 16 shows a flow chart of an odds object winning combination setting process program of the slot machine relating to the present embodiment.

FIG. 17 shows a flow chart of a payout process program of the slot machine relating to the present embodiment.

FIG. 18 shows a flow chart of an odds change setting process program of the slot machine relating to the present embodiment.

FIG. 19 is a drawing showing another example of payout table displayed on the upper image display panel.

FIG. 20 is a drawing showing another example of payout table displayed on the upper image display panel.

FIG. 21 is a drawing showing another example of payout table displayed on the upper image display panel.

FIG. 22 is a drawing showing yet another example of payout table displayed on the upper image display panel.

FIG. 23 is a drawing showing still another example of payout table displayed on the upper image display panel.

FIG. 24 is a drawing showing time-dependent variation of current values of odds of each winning combination for a certain period of time.

FIG. 25 is a drawing showing time-dependent variation of current values of odds of each winning combination for another certain period of time.

FIG. 26 is a drawing showing time-dependent variation of current values of odds of each winning combination for yet another certain period of time.

FIG. 27 is a drawing showing maximum, minimum and standard deviation of current values of odds of each winning combination for a certain period of time.

### DESCRIPTION OF THE PREFERRED EMBODIMENT

In the following, a slot machine as a exemplified embodiment of a gaming machine relating to the present invention is described in detail in reference to the drawings.

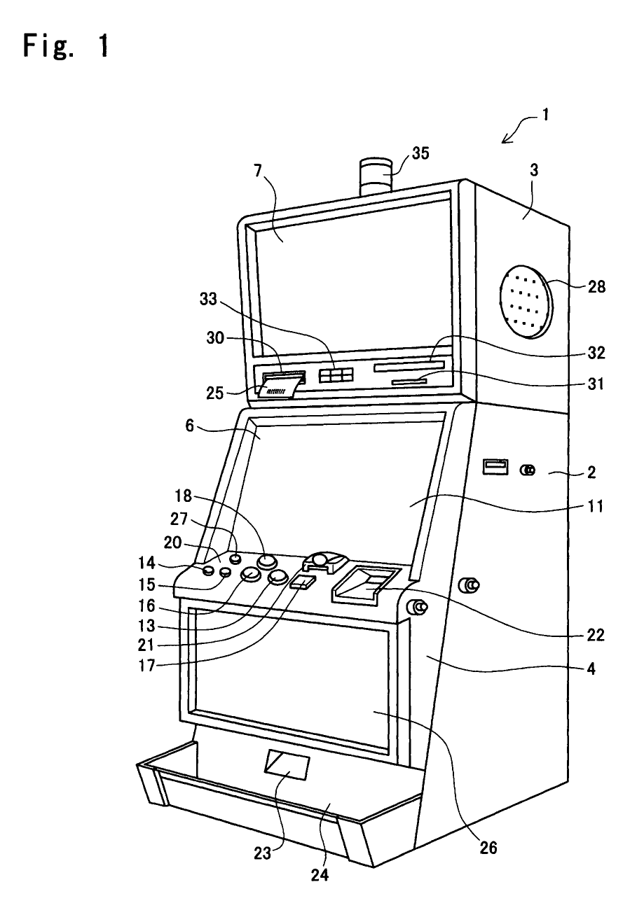

First, a schematic configuration of a slot machine 1 relating to the present embodiment is described based on FIG. 1. FIG. 1 is an external perspective view of the slot machine relating to the present embodiment.

The slot machine 1 relating to the present embodiment comprises a cabinet 2, a top-box 3 placed on the cabinet 2, and a main door 4 placed on the front face of the cabinet 2.

Further, an upper image display panel 7 is placed in front of the top-box 3. Here, the upper image display panel 7 is a publicly known transparent liquid crystal panel, and usually displays information about a game of the slot machine 1, such as a demonstration image, a game rule, and a payout table.

On the other hand, a lower image display panel 6 is provided on the front face of the main door 4.

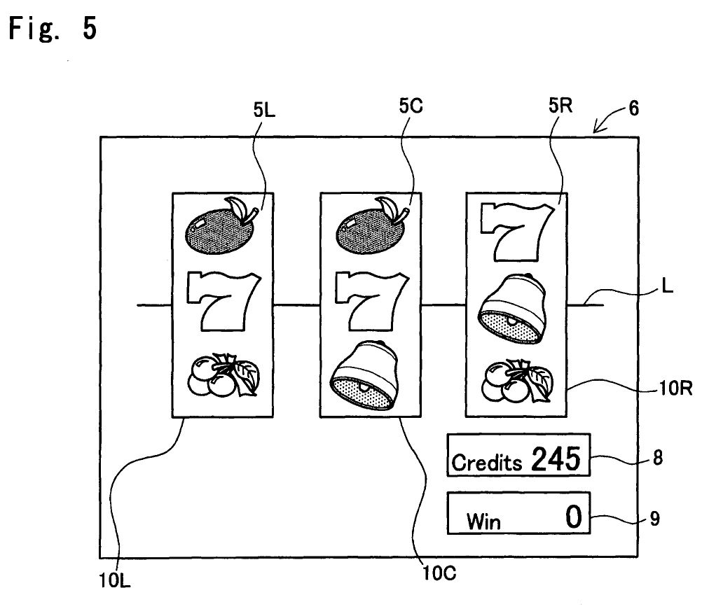

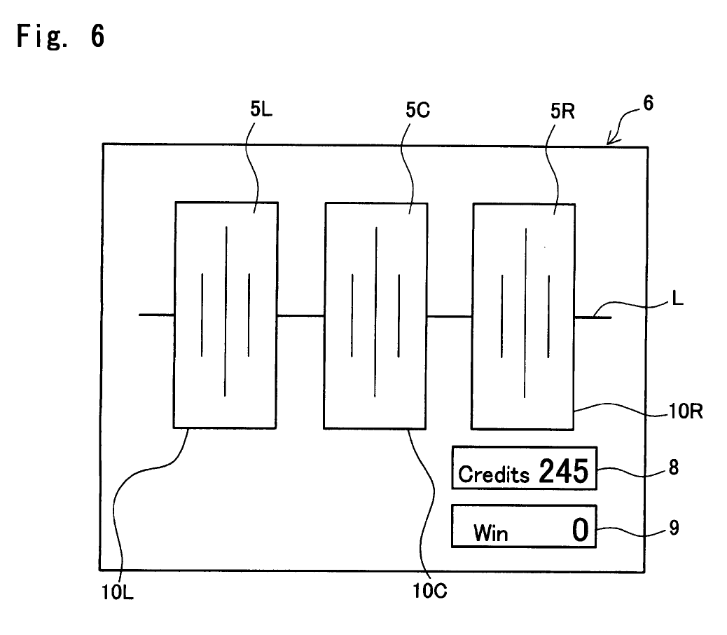

Here, images relating to the game of the slot machine 1, which are displayed on the lower image display panel 6, are described. FIGS. 5 and 6 show images displayed on the lower image display panel 6 as an example of the game. As shown in FIGS. 5 and 6, symbols drawn on the virtual peripheral surface of each of video reels 5L, 5C, and 5R are made visually recognizable through display windows 10L, 10C, and 10R on the lower image display panel 6 during a base game. FIG. 5 shows the symbols in a static state drawn on the virtual peripheral surface of each of the video reels 5L, 5C, and 5R, and FIG. 6 shows the symbols in a rotational state drawn on the virtual peripheral surface of each of the video reels 5L, 5C, and 5R.

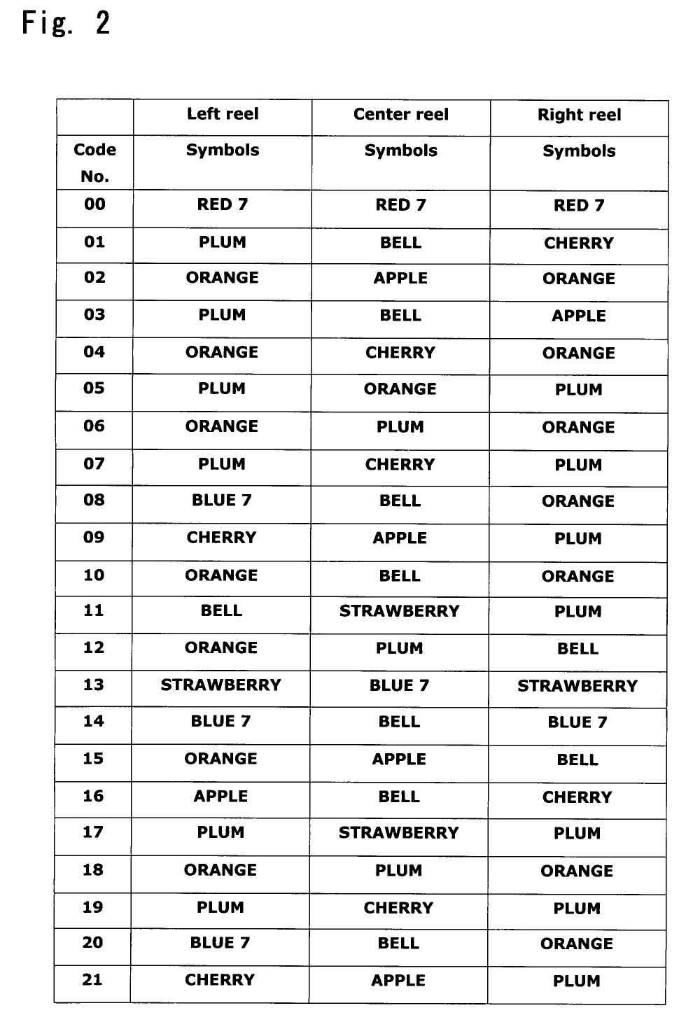

Here, arrays of symbols (refer to FIG. 2) respectively composed of twenty two (22) symbols are drawn on the virtual peripheral surfaces of the three video reels 5L, 5C, and 5R. A touch panel 11 (refer to FIG. 1) is also provided on the front face of the lower image display panel 6 such that a game player can operate the touch panel 11 (refer to FIG. 1) to input various kinds of instructions.

A credit number display part 8 and a payout number display part 9 are also provided on the lower image display panel 6. A credit number owned by the game player is displayed on the credit number display part 8. A payout amount awarded when a combination of symbols stopped and displayed along an activated pay line L coincides with a predetermined combination and a payout amount awarded in a bonus game are displayed on the payout number display part 9 as a payout number.

That is, the three display windows 10L, 10C, and 10R which are in a visually recognizable state are displayed on the lower image display panel 6, and three symbols drawn on each of the virtual peripheral surfaces of the video reels 5L, 5C, and 5R are displayed through each of the display windows 10L, 10C, and 10R. Also, a pay line L which intersects horizontally the three display windows 10L, 10C, and 10R is formed on the lower image display panel 6. The pay line L defines a combination of symbols.

Here, during the bonus game, a predetermined bonus screen, in which the display windows 10L, 10C, and 10R (including each of the video reels 5L, 5C, and 5R) and the pay line L are erased, is displayed with the credit number display part 8 and the payout number display part 9.

Referring back to FIG. 1, a control panel 20 on which a plurality of buttons for inputting instructions of the game player relating to a game progress are arranged, a coin receiving opening 21 for receiving coins which are game media into the cabinet 2, and a bill discrimination unit 22 are placed below the lower image display panel 6.

A spin button 13, a change button 14, a CASHOUT button 15, a 1-BET button 16, a MAX-BET button 17, an ODDS-BET button 18, and an odds selection button 27 are provided on the control panel 20. The spin button 13 is utilized as operating means for inputting an instruction to start the rotation of the video reels 5L, 5C, and 5R. The change button 14 is utilized as operating means for requesting a game hall attendant for change. The CASHOUT button 15 is utilized as operating means for inputting an instruction to have coins corresponding to the credit number (one credit is equivalent to one coin) owned by the game player paid out from a coin payout opening 23 to a coin tray 24, or an instruction to make a payout by means of a ticket 25 with a bar code to be described later.

The 1-BET button 16 is utilized as operating means for inputting an instruction to have one credit bet on the game from among the credits owned by the game player. The MAX-BET button 17 is utilized as operating means for inputting an instruction to have a maximum credit number of credits which can be bet on a single game (50 credits in the present embodiment) bet on the game from among the credits owned by the game player.

The ODDS-BET button 18 is utilized as operating means for inputting an instruction to have additional thirty (30) credits bet on the game from among the credits owned by the game player independently of the 1-BET button 16 and the MAX-BET button 17.

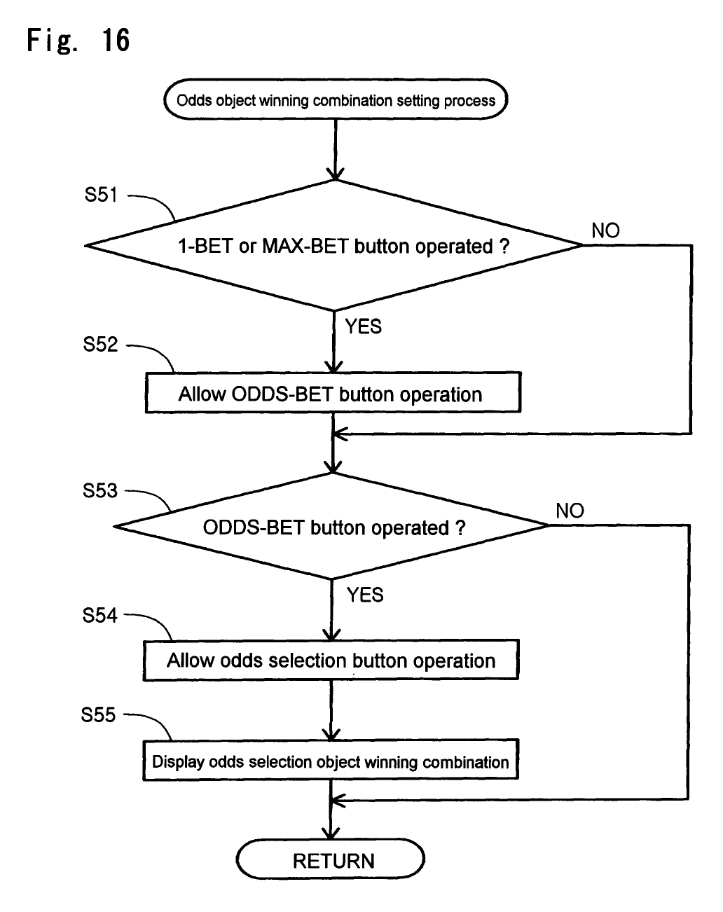

The odds selection button 27 is utilized as operating means for selecting a winning combination which is a bet object according to the ODDS-BET button 18. The operation itself is described later (refer to S55 in FIG. 16).

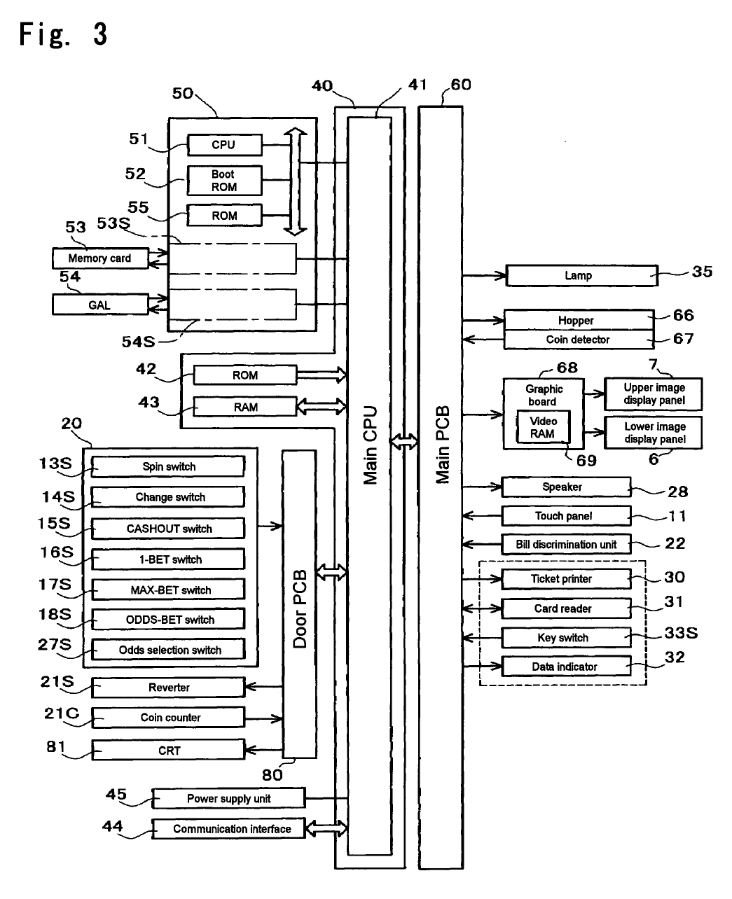

A reverter 21S (refer to FIG. 3) and a coin counter 21C (refer to FIG. 3) are provided inside the coin receiving opening 21. The reverter 21S (refer to FIG. 3) discriminates the coins inserted into the coin receiving opening 21 such that coins and coin-like objects other than the proper coin are ejected from the coin payout opening 23. The coin counter 21C (refer to FIG. 3) detects the accepted proper coins and counts the number of such proper coins.

The bill discrimination unit 22 discriminates the bills such that only proper bills are accepted and directed into the cabinet 2. Then, the bills inserted into the cabinet 2 are converted into the number of coins such that the equivalent number of credits to the converted number of coins are added as credits owned by the game player. The bill discrimination unit 22 is also configured so as to read the ticket 25 with the bar code to be described later. Then, a berry glass 26 on which the characters and the like of the slot machine 1 are drawn is provided on the front face of the lower part of the main door 4, that is, below the control panel 20.

Further, in the slot machine 1 relating to the present embodiment, a coin, a bill, or electronic valuable information (credit) equivalent to the coin and the bill is used as a game medium. However, the game media applicable to the present invention are not limited thereto and may include, by way of example, a medal, a token, electronic money, a ticket, and so on.

A ticket printer 30, a card reader 31, a data indicator 32, and a keypad 33 are provided below the upper image display panel 7.

Here, the ticket printer 30 is a printer for printing on a ticket a bar code, in which the data of the credit number, the date and time, the identification number of the slot machine 1, and the like are encoded, and for providing the ticket 25 with the thus-printed bar code. Then, the game player can let another gaming machine read the thus-provided ticket 25 with the bar code to play a game with the other gaming machine, or utilize the ticket 25 for a procedure at a prescribed place in the game hall.

The card reader 31 performs the reading of data from a smart card and the writing of data in the smart card. The smart card is a card carried by the game player and stores, for example, the history data of the games played by the game player.

The data indicator 32 is composed of a fluorescent display or the like and displays, for example, data read by the card reader 31 or data inputted by the game player through the keypad 33. The keypad 33 is used when instructions and data about ticketing and the like are inputted. Further, a lamp 35 is provided on the upper face of the top-box 3. The lamp 35 is turned on in a predetermined lighting mode for calling a game hall attendant or the like in the case of an error occurring in the slot machine 1 and the like.

Next, the symbols drawn on the virtual peripheral surface of each of the video reels 5L, 5C, and 5R, and variably displayed as being scrolled via the display windows 10L, 10C, and 10R of developing game images on the lower image display panel 6 during the game are described in reference to FIG. 2. FIG. 2 is a schematic diagram showing the arrays of symbols drawn on the virtual peripheral surface of each of the video reels 5L, 5C, and 5R.

Twenty two (22) symbols are drawn on each of the virtual peripheral surfaces of the left video reel 5L, the center video reel 5C, and the right video reel 5R. Each array of symbols is composed of a combination of kinds of symbols: “RED 7”, “BLUE 7”, “BELL”, “CHERRY”, “STRAWBERRY”, “PLUM”, “ORANGE”, and “APPLE”. As shown in FIG. 2, predetermined kinds of symbols are arranged in a predetermined order on the virtual peripheral surface of each of the video reels 5L, 5C, and 5R.

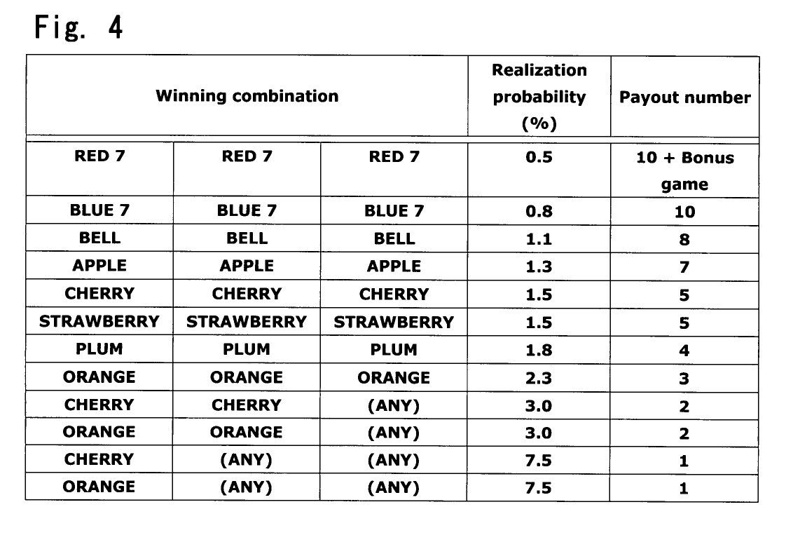

When three symbols of one kind from among “BLUE 7”, “CHERRY”, “STRAWBERRY”, “PLUM”, “ORANGE”, and “APPLE” are stopped and displayed along the pay line L, a predetermined payout amount is awarded to the game player (refer to FIG. 4). Further, as for “CHERRY” and “ORANGE”, even when one (1) or two (2) symbols of the same kind: either “CHERRY” or “ORANGE” are stopped and displayed along the pay line L, a predetermined payout amount is awarded to the game player according to the number of the symbols of the same kind (refer to FIG. 4).

When three (3) symbols of “RED 7” are stopped and displayed along the pay line L, a predetermined payout amount is awarded to the game player, and the game proceeds to the bonus game. Here, the game played on the slot machine 1 relating to the present embodiment comprises two game modes: the base game and the bonus game. In the base game, a game for aiming a specific combination of symbols to be stopped along the pay line L by utilizing the video reels 5L, 5C, and 5R is played. On the other hand, in the bonus game, three treasure boxes as options are displayed on the lower image display panel 6, and a game, in which a payout associated with a treasure box selected by the game player from among the displayed treasure boxes is obtained, is played. The details of the bonus game are omitted here.

Then, the arrays of symbols drawn on the virtual peripheral surface of each of the video reels 5L, 5C, and 5R shown in FIG. 2 are displayed as the symbols are scrolled from top to bottom in the display windows 10L, 10C, and 10R with the rotation of the video reels 5L, 5C, and 5R, when the spin button 13 is depressed after the number of bets is fixed by the operation of the 1-BET button 16 or the MAX-BET button 17 (refer to FIG. 6). After a predetermined time elapses, the arrays of symbols are stopped and displayed in the display windows 10L, 10C, and 10R as the video reels 5L, 5C, and 5R are stopped (refer to FIG. 5). Further, various kinds of winning combinations (refer to FIG. 4) are determined according to the respective combinations of symbols beforehand, and when a combination of symbols corresponding to one of the winning combinations stops along the pay line L, a payout amount corresponding to the stopped winning combination is awarded to the game player.

That is, in the base game, when a combination of symbols stopped and displayed along the pay line L is a predetermined winning combination, a payout amount is awarded according to the winning combination and a credit number (the number of bets) having been bet through the 1-BET button 16 or the MAX-BET button.

Further, in the slot machine 1 relating to the present embodiment, when a bet is made through the ODDS-BET button 18 in addition to the bet through the 1-BET button 16 or the MAX-BET button 17, a resulting payout amount is increased by multiplying the predetermined payout amount by an odds value corresponding to a winning combination having been stopped and displayed if such winning combination coincides with the selected winning combination, which is the bet object of the ODDS-BET button 18.

Next, a configuration relating to the control system of the slot machine 1 according to the present embodiment is described in reference to FIG. 3. FIG. 3 is a block diagram schematically showing the control system of the slot machine 1 according to the present embodiment.

As shown in FIG. 3, the control system of the slot machine 1 basically comprises a motherboard 40 and a gaming board 50.

First, the gaming board 50 is described. The gaming board 50 comprises a CPU 51, a ROM 55, and a boot ROM 52 which are connected to each other via an internal bus, a card slot 53S corresponding to a memory card 53, and an IC socket 54S corresponding to a GAL (Generic Array Logic) 54.

The memory card 53 comprises a nonvolatile memory and is a recording medium in which a game program and a game system program (hereinafter referred to as the game program or the like) are recorded. The game program recorded in the memory card 53 includes a lottery program. The lottery program is a program for determining symbols (respective code numbers corresponding to the symbols) stopped and displayed along the pay line L of the respective video reels 5L, 5C, and 5R. The lottery program includes symbol weighting data corresponding to a plurality of kinds of payout rates (for example, 80%, 84%, and 88%). The symbol weighting data is data indicating a correlation between the code number of each symbol (refer to FIG. 2) and one or more random number values belonging to a prescribed numeric value range (0 to 255) for each of the three video reels 5L, 5C, and 5R. That is, one or more random number values are associated with the code number of one symbol, and when a random number is extracted by a lottery, a symbol specified by the random number value is stopped and displayed.

The payout rate is determined based on payout rate setting data outputted from the GAL 54 and a lottery is conducted based on the symbol weighting data corresponding to the payout rate.

The card slot 53S is provided such that the memory card 53 can be inserted and extracted and the card slot 53S is connected to the motherboard 40 via an IDE bus. Therefore, the kind and the contents of the game played on the slot machine 1 can be changed by rewriting the game program or the like stored in the memory card 53. It is also possible to change the kind and the contents of the game played on the slot machine 1 by replacing the memory card 53 with another memory card 53 storing another game program or the like.

The game program includes the image data of the symbols drawn on the virtual peripheral surface of each of the video reels 5L, 5C, and 5R, image data of the game rule, the payout table, and the like, and image data of demonstration images, in addition to the program relating to the game progress, and image data, sound data, and the like outputted during the game.

The GAL 54 is a type of a PLD (Programmable Logic Device) having an OR-fixed mount type array structure. The GAL 54 comprises a plurality of input ports and output ports and outputs data corresponding to inputted data from the output port when the predetermined data is inputted through the input port. The data outputted from the output port is the aforementioned payout rate setting data.

The IC socket 54S is configured such that the GAL 54 can be attached and removed and the IC socket 54S is connected to the motherboard 40 via a PCI bus. Therefore, the payout rate setting data outputted from the GAL 54 can be changed by rewriting the GAL 54 or replacing the GAL 54 itself.

The CPU 51, the ROM 55, and the boot ROM 52, which are connected to each other via the internal bus, are connected to the motherboard 40 via the PCI bus. The PCI bus transfers signals between the motherboard 40 and the gaming board 50 and supplies electric power from the motherboard 40 to the gaming board 50. The ROM 55 stores country identification information and an authentication program. The boot ROM 52 stores a preliminary authentication program, a program (boot code) for causing the CPU 51 to boot the preliminary authentication program, and the like.

The authentication program is a program (falsification check program) for authenticating the game program or the like. The authentication program is described in accordance with the procedure of the falsification check of the game program or the like which is an authentication loading processing object. The preliminary authentication program is a program for authenticating the authentication program mentioned above and is described in accordance with the procedure of the falsification check of the authentication program which is an authentication processing object.

Next, the motherboard 40 is described. The motherboard 40 may be composed of a commercially available general-purpose motherboard (a printed-wiring board on which the basic parts of a personal computer are mounted) and the motherboard 40 comprises a main CPU 41, a ROM 42, a RAM 43, and a communication interface 44.

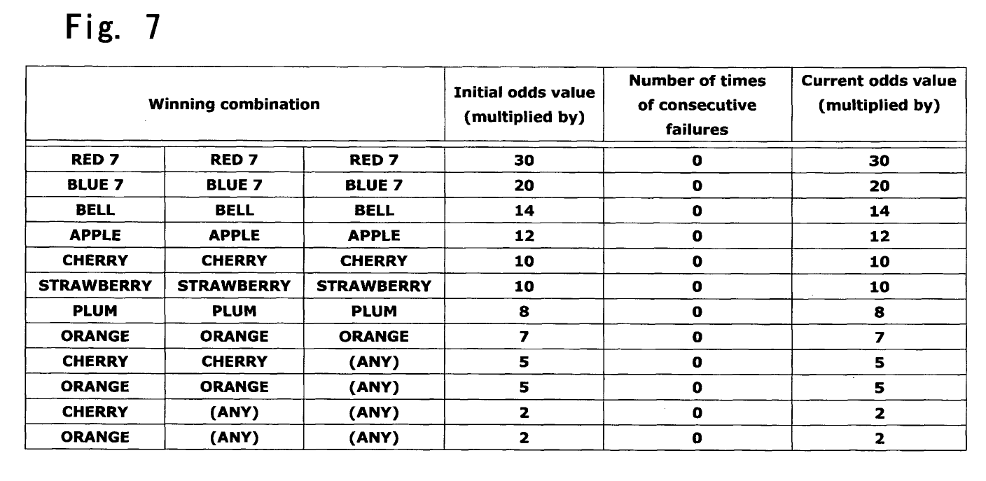

The ROM 42 comprises a memory device such as a flash memory and stores programs such as a BIOS executed by the main CPU 41, and permanent data, such as the lottery tables of the base game and the bonus game, a payout table (refer to FIG. 4), an odds table (refer to FIG. 7) to be described later, and the like. When the BIOS is executed by the main CPU 41, the initialization processing of prescribed peripheral devices are performed and the loading of the game program or the like stored in the memory card 53 is started via the gaming board 50.

The RAM 43 stores data and programs which are used as the main CPU 41 operates. The RAM 43 can also store various kinds of programs such as the authentication program, the game program, and the like, which are read via the gaming board 50, and various kinds of information such as the credit number currently owned by the game player and the like.

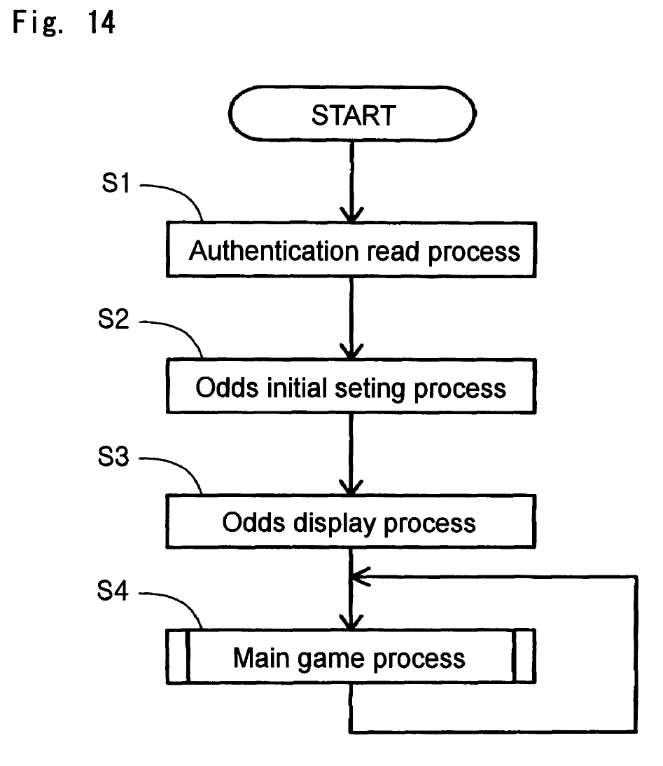

The communication interface 44 is a communication device for performing communication with a server and the like installed in the game hall via a communication line. The slot machine 1 communicates with the server and the like via the communication interface 44 about bet information in a main game process (refer to S4 in FIG. 14) to be described later, the lottery result of a base game lottery process, and the like.

A main PCB 60 and a door PCB 80 to be described later are connected to the motherboard 40 via respective USB connectors. Further, a power supply unit 45 is connected to the motherboard 40. When the power is supplied to the motherboard 40 from the power supply unit 45, the main CPU 41 on the motherboard 40 is started. Further, the power is supplied to the gaming board 50 via the PCI bus to start the CPU 51.

Instruments and devices, which generate input signals for the main CPU 41, and instruments and devices, operations of which are controlled by control signals transmitted from the main CPU 41, are connected to the main PCB 60 and the door PCB 80. The main CPU 41 executes the game program or the like stored in the RAM 43 based on an input signal inputted into the main CPU 41. Then, the main CPU 41 performs a predetermined arithmetic process, thereby storing the results of the arithmetic process in the RAM 43 and performing the control management of each of the instruments and devices.

The lamp 35, a hopper 66, a coin detector 67, a graphic board 68, a speaker 28 (refer to FIG. 1), the touch panel 11, the bill discrimination unit 22, the ticket printer 30, the card reader 31, a key switch 33S, and the data indicator 32 are connected to the main PCB 60.

Here, the touch panel 11 is arranged on the front face of the lower image display panel 6 and specifies the coordinate position of a portion touched by the game player. Thus, it can be determined where the game player touched and further in which direction the touched place moves based on specified coordinate position information.

The hopper 66 is provided inside the cabinet 2 and pays out the predetermined number of coins from the coin payout opening 23 to the coin tray 24 based on the control signal from the main CPU 41. The coin detector 67 is arranged in the coin payout opening 23 and outputs an input signal to the main CPU 41 when it is detected that the predetermined number of coins are paid out from the coin payout opening 23.

The graphic board 68 controls image display on the upper image display panel 7 and the lower image display panel 6 based on a control signal transmitted from the main CPU 41. For example, the credit number owned by the game player, which is stored in the RAM 43, is displayed in the credit number display part 8. Further, the payout number of credits according to the payout is displayed in the payout number display part 9.

Here, the graphic board 68 comprises a VDP (Video Display Processor) which generates image data based on the control signal transmitted from the main CPU 41, a video RAM 69 for temporarily storing the image data generated by the VDP, and the like. The image data, which is used when the VDP generates the image data, is included in the game program.

The graphic board 68 also performs the display control of rotations and stops of the video reels 5L, 5C, and 5R in the lower image display panel 6 (refer to FIGS. 6 and 7) based on the control signal transmitted from the main CPU 41.

The bill discrimination unit 22 discriminates the bill and the ticket 25 with a bar code from improper bill and ticket and accepts the proper bill and ticket 25 with the bar code into the cabinet 2. When accepting the regular bill, the bill discrimination unit 22 outputs an input signal to the main CPU 41 based on the amount of the bill. Further, the bill discrimination unit 22 outputs an input signal to the main CPU 41 based on the number of coins recorded on the proper ticket 25 with the bar code.

The ticket printer 30 prints the bar code, in which the data of the credit number and the like stored in the RAM 43 is encoded, on the ticket based on the control signal outputted from the main CPU 41 and outputs the printed ticket as the ticket 25 with the bar code.

The card reader 31 reads data from a smart card so as to transmit the data to the main CPU 41 and writes data in the smart card based on a control signal transmitted from the main CPU 41. The key switch 33S is provided on the keypad 33 and outputs a predetermined input signal to the main CPU 41 when the keypad 33 is operated by the game player. Based on the control signal outputted from the main CPU 41, the data indicator 32 displays the data read by the card reader 31 or data input by the game player through the keypad 33.

On the other hand, the control panel 20, the reverter 21S, the coin counter 21C, and cold cathode tubes (CRT) 81 are connected to the door PCB 80. A spin switch 13S corresponding to the spin button 13, a change switch 14S corresponding to the change button 14, a CASHOUT switch 15S corresponding to the CASHOUT button 15, a 1-BET switch 16S corresponding to the 1-BET button 16, a MAX-BET switch 17S corresponding to the MAX-BET button 17, an ODDS-BET switch 18S corresponding to the ODDS-BET button 18, and an odds selection switch 27S corresponding to the odds selection button 27 are provided on the control panel 20. Each of the switches outputs an input signal to the main CPU 41 when each corresponding button is operated by the game player.

The coin counter 21C is provided inside the coin receiving opening 21 and discriminates coins inserted into the coin receiving opening 21 by the game player. Objects other than the proper coin are ejected from the coin payout opening 23, and the input signal is outputted to the main CPU 41 when the proper coin is detected.

The reverter 21S operates based on the control signal outputted from the main CPU 41 and distributes coins recognized as the proper ones by the coin counter 21C to the cashbox (not shown) or the hopper 66 installed inside the slot machine 1. The cold cathode tubes 81 are installed on the rear side of the lower image display panel 6 and the upper image display panel 7 such that the cold cathode tubes 81 are lighted based on the control signal transmitted from the main CPU 41 so as to function as backlights.

Next, winning combinations and respective payouts thereof are described in reference to FIG. 4 in the case of the base game played on the slot machine 1 relating to the present embodiment as the video reels 5L, 5C, and 5R are utilized for the base game. FIG. 4 is a payout table showing the winning combinations, the realization probabilities of respective winning combinations thereof, and the payout numbers in the case that the game is played as the video reels 5L, 5C, and 5R are utilized.

Here, the payout number shown in FIG. 4 indicates an payout amount in the case where the number of bets is “1”. Therefore, when the number of bets is “1”, the value of the payout number as shown in FIG. 4 is added to the credit. When the number of bets is “2” or more, the amount given by multiplying the value of the payout number as shown in FIG. 4 by the number of bets is added to the credit.

And the probability of realization of each winning combination as shown in FIG. 4 indicates the probability utilized in the case where the payout rate is 88% if the bonus game is excluded. Here, the realization probability shown in the drawing indicates the probability at which the winning combination is realized when the code number of each of the video reels 5L, 5C, and 5R is determined based on three random number values in reference to the symbol weighting data. That is, the random number value is not necessarily associated with each winning combination.

For example, the probability of realization of the bonus game trigger is 0.5%. When the bonus game trigger is won, three (3) symbols of “RED 7” are stopped and displayed along the pay line such that ten (10) credits are paid out as the award as well as the game proceeds to the bonus game.

Also, the probability of realization of “BLUE 7” is 0.8%. When this combination is realized, three (3) symbols of “BLUE 7” are stopped and displayed along the pay line and ten (10) credits per one bet are paid out as the award.

Also, the probability of realization of “BELL” is 1.1%. When this combination is realized, three (3) symbols of “BELL” are stopped and displayed along the pay line L and eight (8) credits per one bet are paid out as the award.

Similarly, in the following, the realization probability and the payout number are set for each winning combination as shown in FIG. 4. However, when a combination of symbols which does not match any of the combinations shown in FIG. 4 is stopped and displayed, the winning combination is not obtained such that no credits are paid out.

Next, odds in the base game are described in reference to FIGS. 7 to 13. FIG. 7 is an odds table showing the winning combinations and the odds value of each of the winning combinations in the case of playing the base game. Here, the odds values shown in FIG. 7 include initial odds values and current odds values.

The initial odds values shown in FIG. 7 indicate odds values set when initial settings are performed in the base game. In this regard, for each combination, the initial odds value shown in FIG. 7 is set small when the value of the realization probability is high and is set large when the realization probability is low, in consideration of the relative magnitude of the realization probability.

For example, since the probability of realization of the bonus game trigger (“RED 7”) is 0.5% (refer to FIG. 4), the initial odds value is set to “30”.

Also, since the probability of realization of “BLUE 7” is 0.8% (refer to FIG. 4), the initial odds value is set to “20”.

Further, since the probability of realization of “BELL” is 1.1% (refer to FIG. 4), the initial odds value is set to “14”.

In a similar manner for the following winning combinations, each initial odds value is set based on the probability of realization of each combination (refer to FIG. 4).

On the other hand, the current odds values shown in FIG. 7 are odds values set after the initial settings are performed in the base game. The current odds value of each combination is incremented by “1” whenever a game failure is repeated consecutively ten (10) times. Accordingly, in order to manage the number of the consecutively-failed games, an area of recording the number of times of consecutive failures is provided in the odds table as shown in FIG. 7 for each combination.

The odds table as shown in FIG. 7 is stored in the ROM 42, read from the ROM 42 when the main CPU 41 operates, and stored in the RAM 43. Thus, it is possible to change the number of times of consecutive failures and the current odds value.

As shown in the odds table of FIG. 7, when the main CPU 41 operates and the initial settings are performed for the base game, the initial odds value and the current odds value are identical for each combination, and the number of times of consecutive failures is “0”.

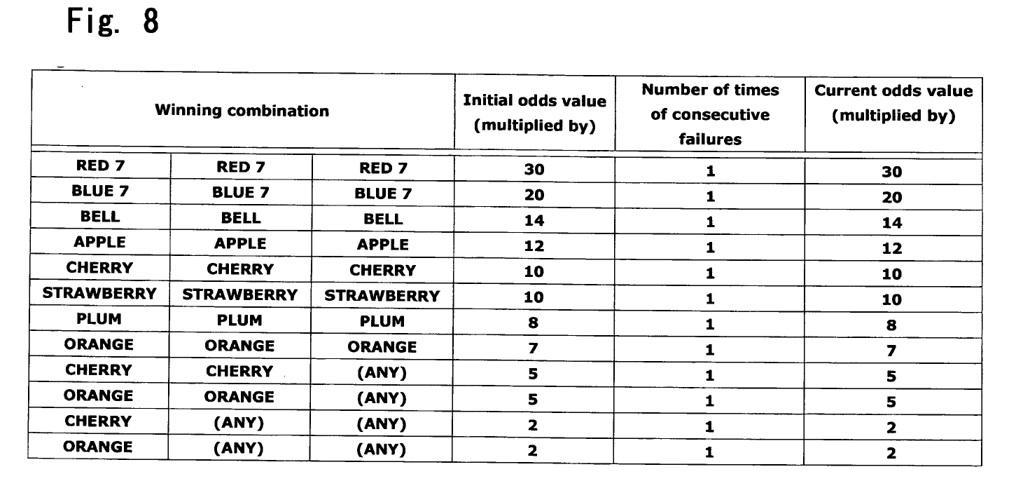

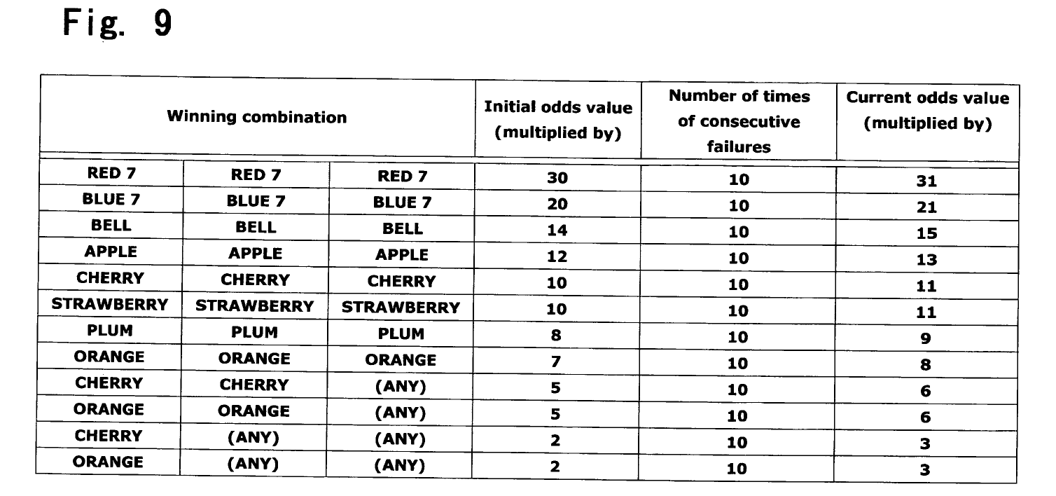

Then, for example, when the base game is played for the first time after the initialization such that no winning combination is realized, the odds table shown in FIG. 7 turns into an odds table shown in FIG. 8. Although the current odds value for each combination does not change, the number of times of consecutive failures is set to “1”. Further, for example, when the base game is played nine (9) more times and no winning combination is realized in the consecutive base games, the odds table shown in FIG. 8 turns into an odds table shown in FIG. 9 such that the current odds value for each combination is incremented by “1”. Thus, the number of times of consecutive failures is set to “10”.

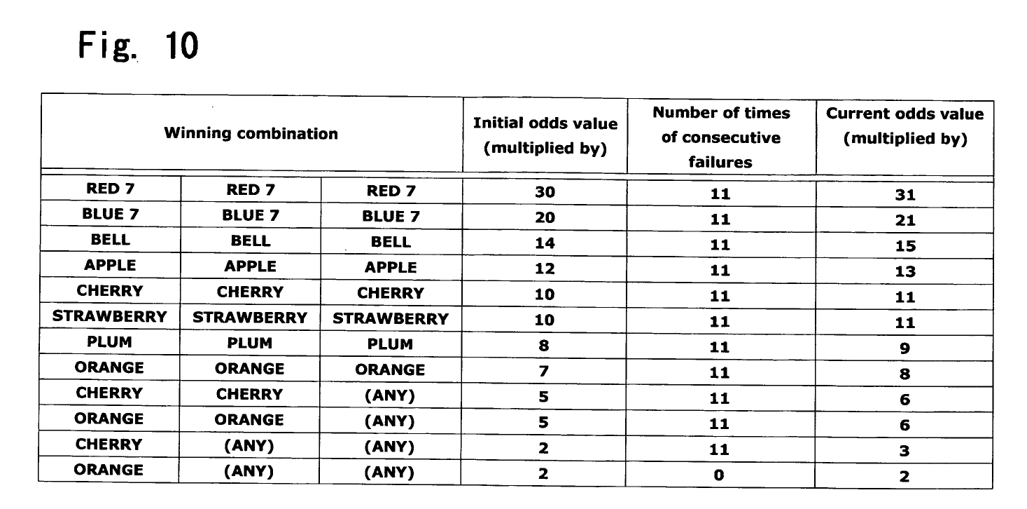

Then, for example, when the base game is played once such that a combination, in which one “ORANGE” is stopped and displayed along the pay line L, is realized, the odds table shown in FIG. 9 turns into an odds table shown in FIG. 10. In this regard, as for the realized combination, the current odds value returns to “2” of the initial odds value, and the number of times of consecutive failures also returns to “0”. On the other hand, as for the combinations other than the realized combination, the current odds value does not change, but the number of times of consecutive failures is set to “11”.

Thus, the number of times of consecutive failures provided for each winning combination in the odds table is incremented by “1” whenever the game, in which the corresponding winning combination is not realized, is played. On the other hand, whenever the number of times of consecutive failures of the winning combination becomes “10”, “20”, “30”, . . . , the current odds value provided for each combination in the odds table is incremented by “1”. And the game player can learn the current status in the payout table displayed on the upper image display panel 7.

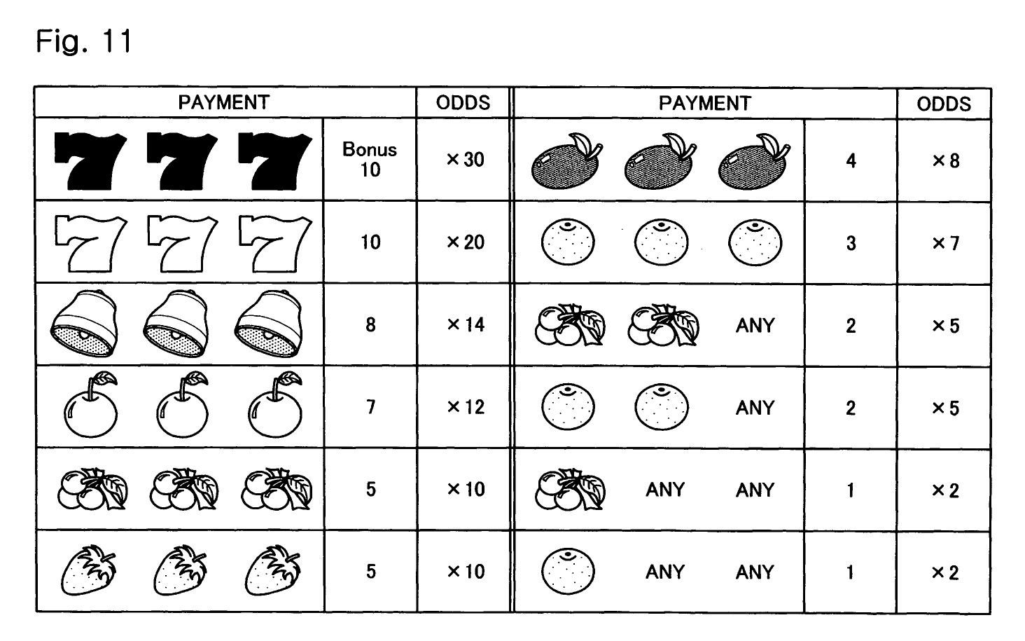

That is, when the initial settings are performed in the base game, the payout table shown in FIG. 11 is displayed. In this regard, the payout table as shown in FIG. 11 indicates symbols constituting each of the combinations, each payout rate corresponding to each of the winning combinations, and the current odds value corresponding to each of the winning combinations. Although the display of the symbols showing each winning combination or each payout rate corresponding to each winning combination is not changed, display of the current odds value corresponding to each winning combination is changed as described below.

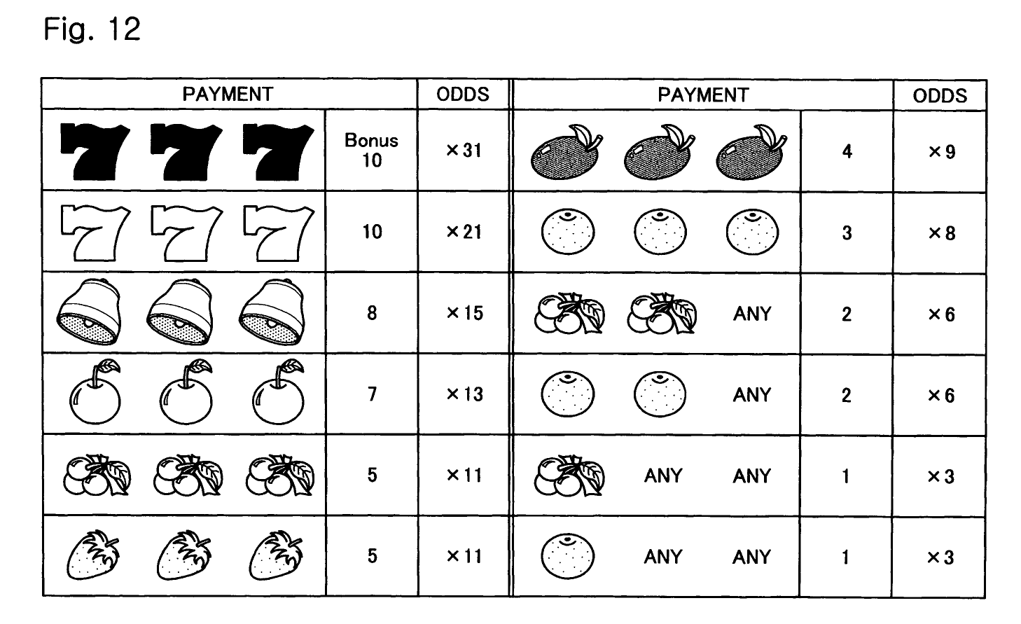

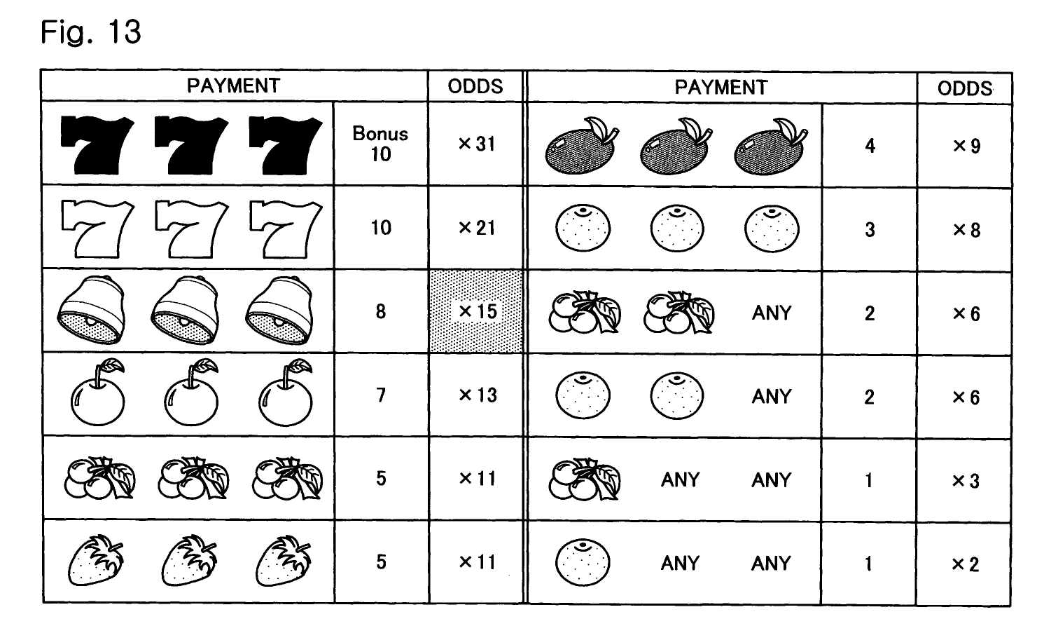

For example, as mentioned above, when the initial settings are performed in the base game, the payout table shown in FIG. 11 is displayed on the upper image display panel 7. Then, for example, when the base game is played for the first time after the initialization such that no winning combination is realized, the payout table shown in FIG. 11 is displayed on the upper image display panel 7. Further, for example, when the base game is played nine (9) more times such that no winning combination is realized, a payout table shown in FIG. 12 is displayed on the upper image display panel 7. Then, for example, when the base game is played once such that a winning combination is realized, in which one “ORANGE” is stopped and displayed along the pay line L, a payout table shown in FIG. 13 is displayed on the upper image display panel 7.

The display control of the payout table in the upper image display panel 7 is implemented when each current odds value in the odds table stored in the RAM 43 is sent by the main CPU 41 to the graphic board 68 along with a display signal.

Subsequently, a main control program executed in the slot machine 1 relating to the present embodiment is described in detail in reference to the drawings. FIG. 14 shows a flowchart of the main control program.

In the slot machine 1, the memory card 53 is assumed to be already inserted into the card slot 53S of the gaming board 50, and the GAL 54 is assumed to be mounted on the IC socket 54S.

First, when an electric power switch is turned on (application of power) in the power supply unit 45, the motherboard 40 and the gaming board 50 are started, respectively, and an authentication read process of step (in the following, abbreviated as ‘S’) 1 is executed. In this authentication read process, the motherboard 40 and the gaming board 50 performs separately respective processes in parallel.

That is, in the gaming board 50, the CPU 51 performs the reading process of the preliminary authentication program stored in the boot ROM 52 and conducts a preliminary authentication process for confirming and verifying in advance that the authentication program is not falsified before loading into the motherboard 40 in accordance with the read preliminary authentication program.

On the other hand, in the motherboard 40, the main CPU 41 executes the BIOS stored in the ROM 42, decompresses compressed data built into the BIOS in the RAM 43, and then executes the BIOS having been decompressed in the RAM 43 as well as the diagnosis and the initialization of various peripheral devices.

Subsequently, the main CPU 41 reads the authentication program stored in the ROM 55, and performs authentication for confirming and verifying that the game program stored in the memory card 53 inserted in the card slot 53S is not falsified. When this authentication process is completed normally, the main CPU 41 writes the (authenticated) game program and the like subject to the authentication process into the RAM 43 and acquires the payout rate setting data and the country identification information.

After the aforementioned processes, the main CPU 41 terminates the authentication read process.

Then, an odds initial setting process is performed in S2. In this odds initial setting process, the main CPU 41 reads the odds table stored in the ROM 42 (refer to FIG. 7) from the ROM 42 and stores the thus-read odds table in the RAM 43.

Then, an odds display process is performed in S3. In this odds display process, the main CPU 41 transmits each current odds value in the odds table stored in the RAM 43 along with a display start signal to the graphic board 68. On the other hand, upon receiving each current odds value along with the display start signal, the graphic board 68 displays the payout table in which each received current odds value is reflected on the upper image display panel 7 (refer to FIG. 11).

Then, in S4, the main CPU 41 sequentially reads the game program and the like authenticated in the authentication read process of S1 from the RAM 43 and executes the game program to perform the main game process. The game in the slot machine 1 relating to the present embodiment is played by executing this main game process. Then, while the power is supplied to the slot machine 1, the main game process is repeatedly executed.

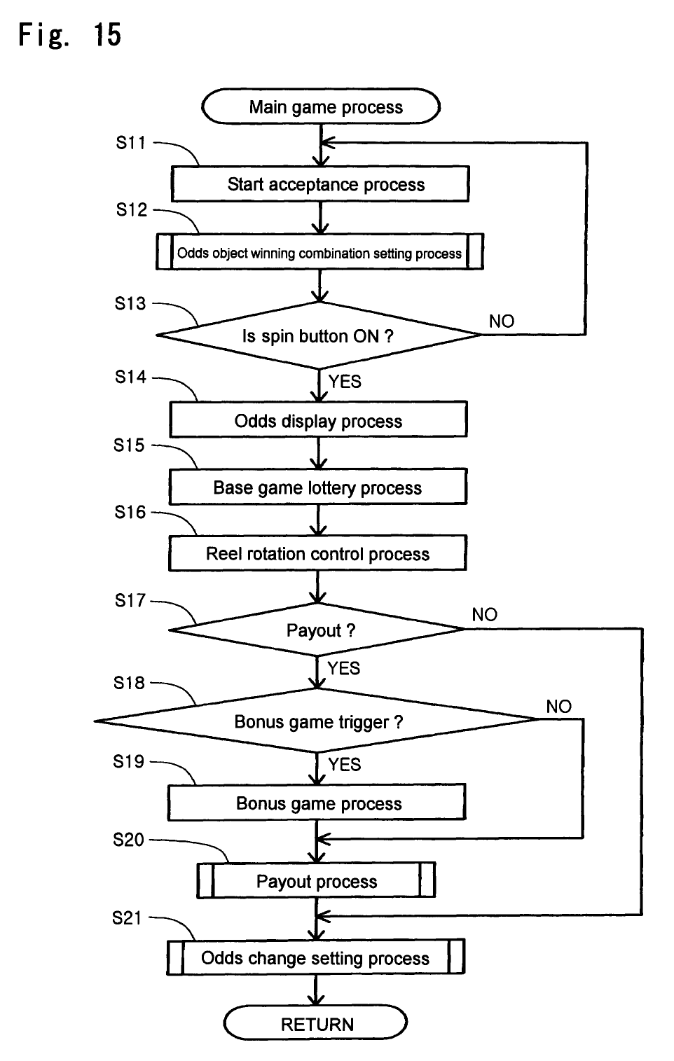

Next, the sub process of the main game process in S4 is described based on FIG. 15. FIG. 15 shows a flowchart of the main game process program in the slot machine 1 relating to the present embodiment. Each program shown in the flowchart in FIG. 15 is stored in the ROM 42 and the RAM 43 provided in the slot machine 1 and executed by the main CPU 41 as described below.

First, as shown in FIG. 15, in S11, the main CPU 41 performs the start acceptance process for setting the number of bets for the pay line L, the insertion of coins, and the like after the predetermined initial setting. At this time, in the start acceptance process, the game player inserts a coin or performs a bet operation with the 1-BET button 16 and the MAX-BET button 17.

Next, in S12, the main CPU 41 performs an odds object winning combination setting process (a setting process for a winning combination as an odds object).

Then, the sub process of the odds object winning combination setting process of S12 is described based on FIG. 16. FIG. 16 shows a flowchart of an odds object winning combination setting process program of the slot machine 1 relating to the present embodiment. Each program as shown in the flowchart in FIG. 16 is stored in the ROM 42 and the RAM 43 provided in the slot machine 1 such that the main CPU 41 executes each program.

First, as shown in FIG. 16, in S51, the main CPU 41 determines whether the 1-BET button 16 or the MAX-BET button 17 is operated. Here, when the 1-BET button 16 or the MAX-BET button 17 is operated (S51: YES), the program proceeds to S52 such that the CPU 41 allows the operation of the ODDS-BET button 18. After S52 is executed and also after it is determined that neither 1-BET button 16 nor MAX-BET button 17 is operated (S51: NO), the program proceeds to S53 and the main CPU 41 determines whether or not the ODDS-BET button 18 is operated. Here, when the ODDS-BET button 18 is operated (S53: YES), the program proceeds to S54 and the CPU 41 allows the operation of the odds selection button 27.

Subsequently, the program proceeds to S55 and the odds selection object winning combination is displayed. The odds selection object winning combination is a winning combination as a bet object of the ODDS-BET button 18. At this time, the current odds value for the winning combination of the odds selection object is highlighted or displayed in a reverse mode on the upper image display panel 7. For example, as shown in FIG. 13, the current odds value of “BELL” for the winning combination of the odds selection object is highlighted. Thus, the winning combination of the odds selection object is displayed. Here, when the odds selection button 27 is depressed, the main CPU 41 shifts the reverse display from a box of a current odds value to another box of another current odds value for another winning combination via the graphic board 68 for each depression. This enables the game player to select the winning combination of the odds selection object.

Here, a way of displaying the odds selection object winning combination by highlighting the current odds value is one example and the current odds selection object winning combination itself may be displayed with the current odds value on the upper image display panel 7 or the like. Further, there may be a plurality of winning combinations of the odds selection objects.

After S55 is executed or also after it is determined that the ODDS-BET button 18 is not operated (S53: NO), the program returns to the main game process of FIG. 15 as mentioned above.

Returning to the main game process of FIG. 15, next, in S13, the main CPU 41 determines whether or not the spin button 13 is inputted. The determination whether or not the spin button 13 is inputted is made based on whether or not an input signal is received from the spin switch 13S.

When the spin button 13 is not inputted (S13: NO), the program returns to the start acceptance process (S11) again. The operations of correction of the number of the bets and the like are enabled at this time. On the other hand, when the spin button 13 is inputted (S13: YES), the number of bets set to the pay line L based on the operations of the 1-BET button 16, the MAX-BET button 17, and the ODDS-BET button 18 is subtracted from the credit number owned by the game player, and the resultant data is stored in the RAM 43 as bet information. In addition, in the bet information, the bet set by the operation of the 1-BET button 16 or the MAX-BET button 17 and the bet set by the operation of the ODDS-BET button 18 are distinguished. When the operation of the ODDS-BET button 18 is allowed, the winning combination (winning combination of the odds selection object) corresponding to the current odds value highlighted on the upper image display panel 7 is also stored.

Then, in S14, the main CPU 41 performs an odds display process. In this odds display process, the main CPU 41 transmits each current odds value of the odds table stored in the RAM 43 with a display change signal to the graphic board 68. On the other hand, upon receiving each current odds value with the display change signal, the graphic board 68 redisplays the payout table which reflects each of the received current odds value on the upper image display panel 7 (for example, refer to FIGS. 11 to 13).

Therefore, the game player can learn that the current odds value of each winning combination is changed (incremented by “1” or reset to the initial odds value), after operating the ODDS-BET button 18 or the odds selection button 27. Thus, it becomes possible to provide impression of being lucky or unlucky to the game player for the change of the current odds value. Incidentally, the game player may be informed that the current odds value of each combination is changed (incremented by “1” or reset to the initial odds value) before operating the ODDS-BET button 18 or the odds selection button 27.

Then, the main CPU 41 executes the base game process using the video reels 5L, 5C, and 5R in S15 and later.

First, in S15, the main CPU 41 performs the lottery process in the base game. Specifically, the random number value corresponding to each of the three video reels 5L, 5C, and 5R is selected from among a numeric value range of “0 to 255” by executing a random number generating program included in the lottery program stored in the RAM 43. Then, based on the three random number values selected with reference to the symbol weighting data corresponding to the payout rate setting data, the main CPU 41 determines the code number (refer to FIG. 2) of each of the video reels 5L, 5C, and 5R. After storing the code number of each of the determined video reels 5L, 5C, and 5R into the RAM 43, the program shifts to S16.

Here, since the code number of each of the video reels 5L, 5C, and 5R corresponds to the code number of a symbol stopped and displayed along the pay line L, a combination in the game is determined when the main CPU 41 determines the code number of each of the video reels 5L, 5C, and 5R. For example, when the code numbers of the respective video reels 5L, 5C, and 5R are determined as “00”, “00”, and “00”, it means that the main CPU 41 determines the combination as “RED 7”, Thus, a lottery relating to a usual combination (refer to FIG. 4) is held by determining the code number of each of the video reels 5L, 5C, and 5R.

Next, in S16, the main CPU 41 performs a reel rotation control process. The reel rotation control process is a process of stopping the rotation of each of the video reels 5L, 5C, and 5R so that the combination of symbols determined in the base game lottery process (S15) is stopped and displayed along the pay line L after starting the rotation of all the video reels 5L, 5C, and 5R. This process is performed between the main CPU 41 and the graphic board 68.

To be described more specifically, in the reel rotation control process (S16), the main CPU 41 transmits first a start signal to the graphic board 68, indicating that the rotation of the video reels are to be started. Upon receiving the start signal, the graphic board 68 performs the video reel rotation display process. That is, the graphic board 68 performs display control for starting the rotation state of each of the video reels 5L, 5C, and 5R in the lower image display panel 6.

Then, after transmission of the start signal, the main CPU 41 determines effect modes (such as the display of images on the upper image display panel 7, the output of sound from the speaker 28, and the like) for one game, and starts an effect in a determined effect pattern.

Then, when a predetermined stop timing for stopping the video reels 5L, 5C, and 5R in the rotation state is reached, the main CPU 41 transmits the code numbers of the video reels stored in the RAM 43 to the graphic board 68. The graphic board 68 executes a video reel stop and display process based on the code numbers of the video reels. As a result, on the lower image display panel 6, the symbols corresponding to the lottery result are stopped and displayed along the pay line L in each of the display windows 10L, 10C, and 10R.

Next, in S17, the main CPU 41 determines whether or not the winning combination for conducting a payout is realized. As a result, when any one of the winning combinations as shown in FIG. 4 is realized (S17: YES), the program shifts to S18. On the other hand, when none of the winning combinations are realized (S17: NO), this program is executed again.

In S18, the main CPU 41 determines whether or not the bonus game trigger is realized in the base game. Specifically, when using the payout table of FIG. 4, the bonus game trigger is determined to be realized when the winning combination of the symbol of “RED 7” is stopped and displayed along the pay line L.

Then, when it is determined that the bonus game trigger is realized (S18: YES), a selective bonus game process is executed in S19. The details of the bonus game process is, however, omitted here. After S19 is executed and also when it is determined that the bonus game trigger is not realized (S18: NO), the payout process is performed (S20).

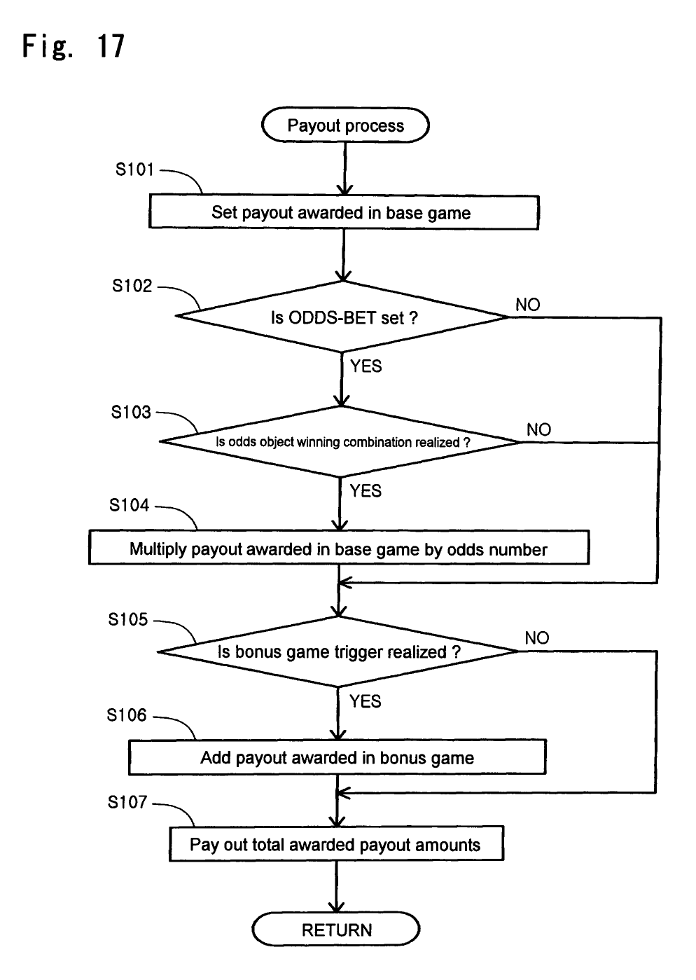

Here, the sub process of the payout process in S20 is described based on FIG. 17. FIG. 17 shows a flowchart of the payout process program in the slot machine 1 relating to the present embodiment. Each program shown below on the flowchart in FIG. 17 is stored in the ROM 42 and the RAM 43 provided to the slot machine 1, and executed by the main CPU 41.

First, as shown in FIG. 17, in S101, the main CPU 41 sets a payout awarded in the base game to the RAM 43. Next, in S102, the main CPU 41 determines whether or not the bet by the operation of the ODDS-BET button 18 is set based on the bet information stored in he RAM 43. When the bet by the operation of the ODDS-BET button 18 is set here (S102: YES), the program proceeds to S103.

In S103, the main CPU 41 determines whether or not the combination realized in the base game matches a winning combination of the odds selection object. When the combination realized in the base game matches the winning combination of the odds selection object (S103: YES), the program proceeds to S104.

In S104, the main CPU 41 specifies the current odds value corresponding to the combination realized in the base game from the odds table stored in the RAM 43 and multiplies the awarded payout amount in the base game in the RAM 43 by the specified current odds value to determine the total awarded payout of the present game. After S104 is executed and also when the bet by the operation of the ODDS-BET button 18 is not set (S102: NO) and when the combination realized in the base game does not match the winning combination of the odds selection object (S103: NO), the program proceeds to S105.

In S105, the main CPU 41 determines whether or not the bonus game is performed. Here, when it is determined that the bonus game is performed (S105: YES), the main CPU 41 proceeds to S106. In S106, the main CPU 41 adds a payout awarded in the bonus game to the total awarded payout of the present game set in the RAM 43 to determine a new total awarded payout of the present game. After S106 is executed and also when it is determined that the bonus game is not performed (S105: NO), the program proceeds to S107.

In S107, the main CPU 41 pays out the total awarded payout amount of the present game set in the RAM 43 to the game player. At this time, coins corresponding to the credit number (one credit corresponds to one coin) may be paid out, and also the ticket 25 with the bar code may be paid out when the CASHOUT button 15 is depressed. Subsequently, the program returns to the main game process of FIG. 15 as mentioned above.

Returning to the main game process of FIG. 15, the program proceeds to S21 and performs an odds change setting process.

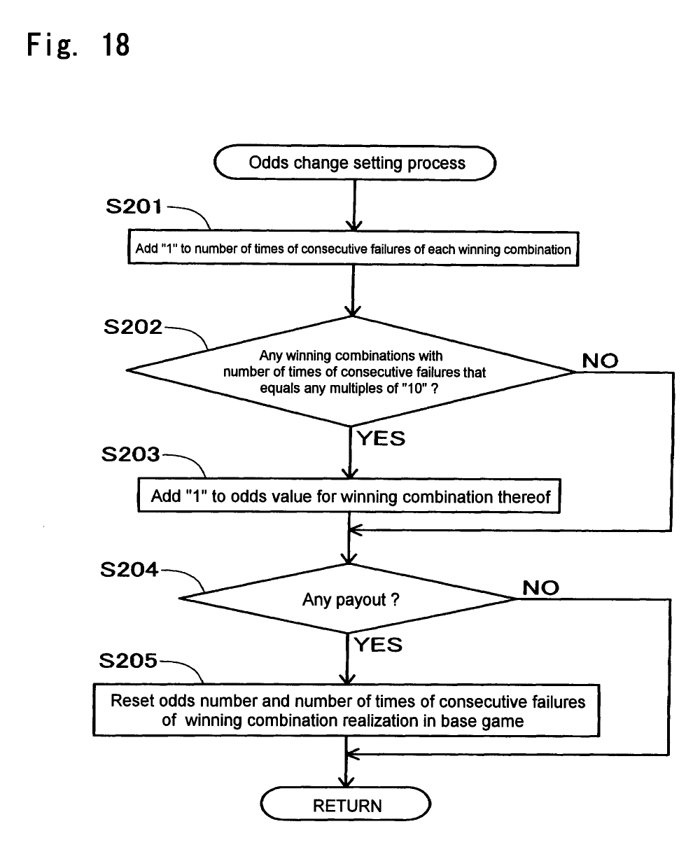

Here, the sub process of the odds change setting process of S21 is described based on FIG. 18. FIG. 18 shows a flowchart of the odds change setting process program in the slot machine 1 relating to the present embodiment. Each program shown below on the flowchart in FIG. 18 is stored in the ROM 42 and the RAM 43 provided to the slot machine 1 and executed by the main CPU 41.

First, as shown in FIG. 18, in S201, the main CPU 41 adds “1” to the number of times of consecutive failures for each winning combination of the odds table stored in the RAM 43 (refer to FIGS. 7 and 8, for example). Then, in S202, the main CPU 41 determines whether or not there are any winning combinations whose number of times of consecutive failures in the odds table stored in the RAM 43 is a multiple of “10” (excluding “0”). When there is the winning combination whose number of times of consecutive failures in the odds table stored in the RAM 43 is the multiple of “10” (excluding “0”) (S202: YES), the main CPU 41 proceeds to S203 and adds “1” to the current odds value of the combination whose number of times of consecutive failures is the multiple of “10” (excluding “0”) in the odds table stored in the RAM 43 (refer to FIGS. 8 and 9, for example). After S203 is executed and also when there is no winning combination whose number of times of consecutive failures in the odds table stored in the RAM 43 is the multiple of “10” (excluding “0”) (S202: NO), the program proceeds to S204.

In S204, the main CPU 41 determines whether or not the payout in the slot machine 1 is performed. When the payout in the slot machine 1 is performed (S204: YES), the program proceeds to S205 and sets the number of times of consecutive failures corresponding to the realized winning combination of the base game to “0” in the odds table stored in the RAM 43, and returns the current odds value corresponding to the realized combination of the base game to the initial odds value (refer to FIG. 10). Incidentally, the initial odds values are set in the odds table stored in the ROM 42 in advance (refer to FIG. 7).

After S205 is executed and also when the payout in the slot machine 1 is not performed (S204: NO), the program returns to the main game process of FIG. 15.

Subsequently, returning to the main game process of FIG. 15, then, this program is executed again.

As described above in detail, in the base game played on the slot machine 1 relating to the present embodiment, when the combination of the symbols stopped and displayed along the pay line L is the predetermined winning combination, a payout amount corresponding to the combination and the credit number (the number of bets) bet by using the 1-BET button 16 or the MAX-BET button 17 is awarded (S101). Further, when the bet is made by the ODDS-BET button 18 in addition to the bet by the 1-BET button 16 or the MAX-BET button 17 (S102: YES), and when the odds selection object winning combination selected by the odds selection button 27 matches the combination stopped and displayed along the pay line L (S103: YES), the payout amount is increased by multiplying the current odds value corresponding to the stopped and displayed winning combination (S104).

In this regard, whenever the failed game is repeated 10 times consecutively, the current odds value corresponding to each combination is incremented by “1” (S202: YES, S203), and the current odds value is displayed in the payout table on the upper image display panel 7 (S14). Therefore, if the current odds value of the winning combination having a high realization probability increases, the game player learns that matter from the payout table on the upper image display panel 7, and comes to think that it is the best to make an additional bet by using the ODDS-BET button 18, and to select a winning combination of the odds selection object by using the odds selection button 27 in order to obtain many payouts with a high probability since the realization probability of the combination is high and there is a large number of times of consecutive failures of the combination. That is, since it is possible to play a high payout amount game in which a payout is increased by the current odds value increased according to the repeated number of times of the failed games if the additional bet is made by using the ODDS-BET button 18, an interest in the game of the game player can be strongly improved.

In a probability theory, there is such a phenomenon called “breakaway” in which an event concerned does not occur even when trial frequency reaches the region which is equal to or less than the probability. If this is applied to the present embodiment, the occurrence of a case is anticipated in which a current odds value significantly increases according to the repeated number of times of the failed games. Therefore, it is possible to enjoy the game which makes a fortune at one stroke can be realized not by luck unrelated to a game operation like a conventional progressive bonus but by the decision and the operation of the game player.

Since the game player comes to think of making an additional bet by using the ODDS-BET button 18 even from a stage where a current odds value is not increased for winning a large amount of payout on speculation, a gambling nature can be imparted to the game.

The present invention is not limited to the above embodiment, and various modifications may be made within a scope without departing from the spirit.

For example, when the additional bet is made by using the ODDS-BET button 18, that effect may be displayed on the lower image display panel 6.

Further, when the additional bet is made by using the ODDS-BET button 18, all the combinations or a part of combinations may be considered as an odds selection object winning combination regardless of a selection by the odds selection button 27.

In the present embodiment, the current odds value provided for each winning combination in the odds table is incremented by “1” whenever the number of times of consecutive failures of the winning combination concerned becomes “10”, “20”, “30”, . . . , but the present invention is not limited thereto. For example, whenever the number of times of consecutive failures of a winning combination reaches each value which forms a random or regular sequence, the current odds value of the combination may be increased. The value added to the current odds value may be a predetermined value other than “1”, or each single value which forms the random or regular sequence may be selected. The incremental means of the current odds value may employ not only addition but also integration.

Further, in the present embodiment, the example in which the present invention is applied to the slot machine is described, but it is also possible to apply the present invention, by way of example, to a pachi-slot machine, a poker gaming machine, and the like for domestic use only.

The present invention can be applied to the technology of determining a payout awarded according to the combination of symbols displayed in a gaming machine.

Another example of the game, in which initial values and current values to be incremented in the same condition as shown in FIG. 7 of the odds are utilized and winning probabilities and payout rates of respective winning combinations as shown in FIG. 4 are utilized, is explained in reference to FIGS. 9 to 27.

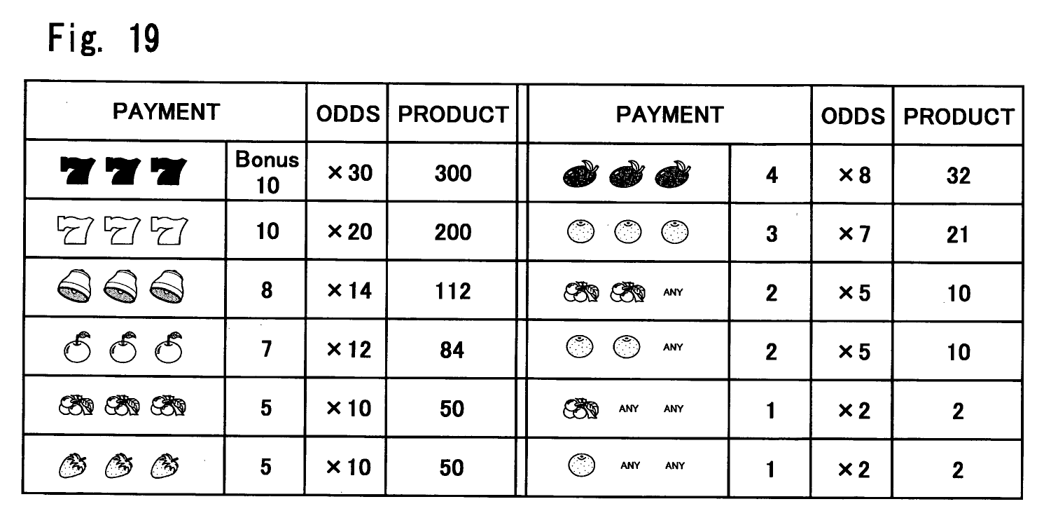

That is, when the initial settings are performed in the base game, the payout table shown in FIG. 19 is displayed. The figure is identical to FIG. 11 except having a “PRODUCT” column. In the “PRODUCT” column, the products of corresponding payout rates and odds values are shown. For example, that 10 times 30 equals 300, which is rather easy to calculate, and that 8 time 14 equals 112, which is not necessarily easy to calculate are shown. From this figure, the player can easily understand how many credit numbers will be actually paid out so as to play the game with ease mentally and physically. The payout rates and initial odds values are determined according to the respective winning probabilities of the winning combinations such that they are in the order from RED 7 to one ORANGE. Therefore, the values in the “PRODUCT” column are also in the same order.

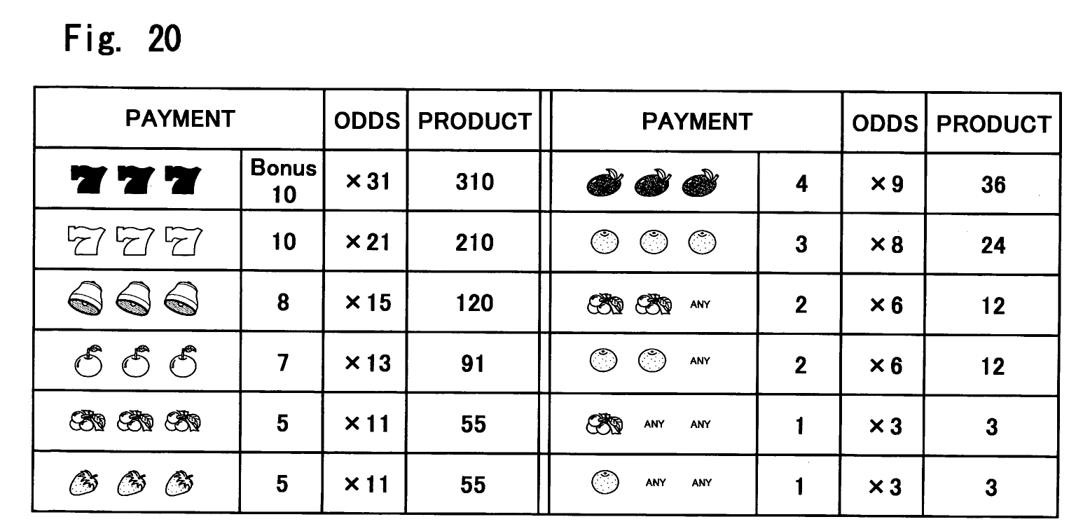

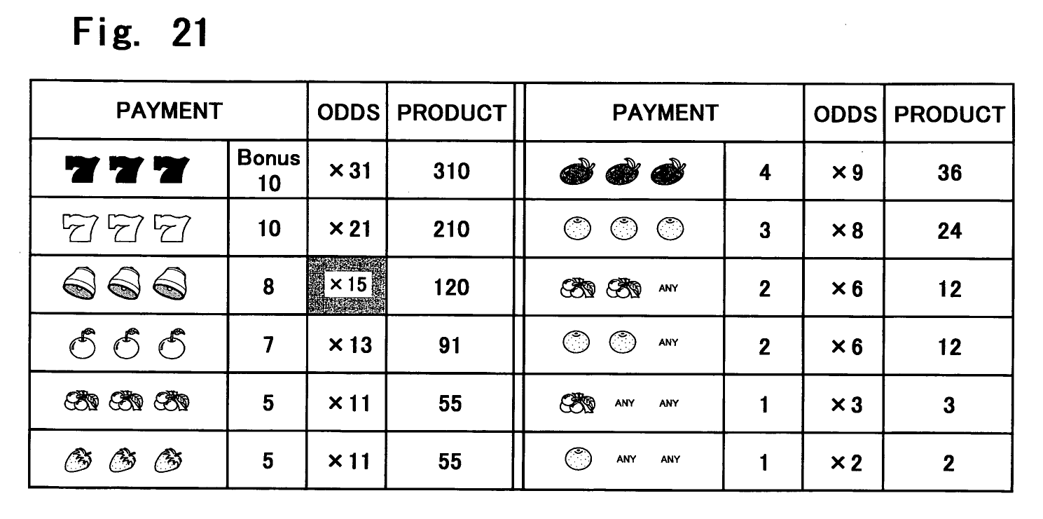

Then, for example, when the base game is played for the first time after the initialization such that no winning combination is realized, and the base game is played nine (9) more times such that no winning combination is realized, a payout table shown in FIG. 20 is displayed on the upper image display panel 7. This figure is also identical to FIG. 12 except the “PRODUCT” column. Then, for example, when the base game is played once such that a winning combination is realized, in which one “ORANGE” is stopped and displayed along the pay line L, a payout table shown in FIG. 21 is displayed on the upper image display panel 7. This figure is also identical to FIG. 13 except the “PRODUCT” column.

As shown in FIGS. 12, 13, 20, and 21, the values of the current odds vary as the are increased by one or returned to the initial value. Therefore, the situation where the payout amount can not be calculated easily may occur. Then, it is preferable to have the “PRODUCT” column as shown in FIGS. 19 to 21.

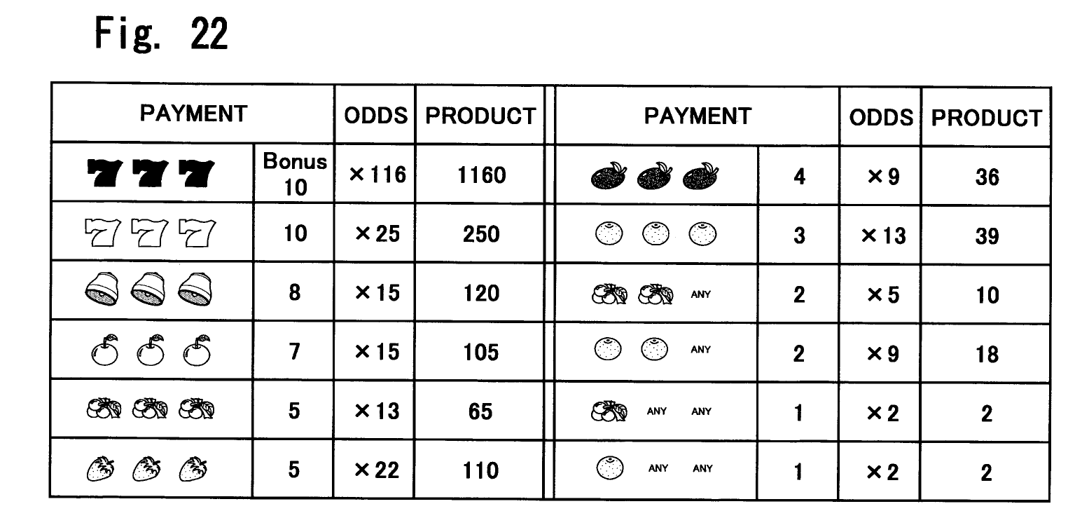

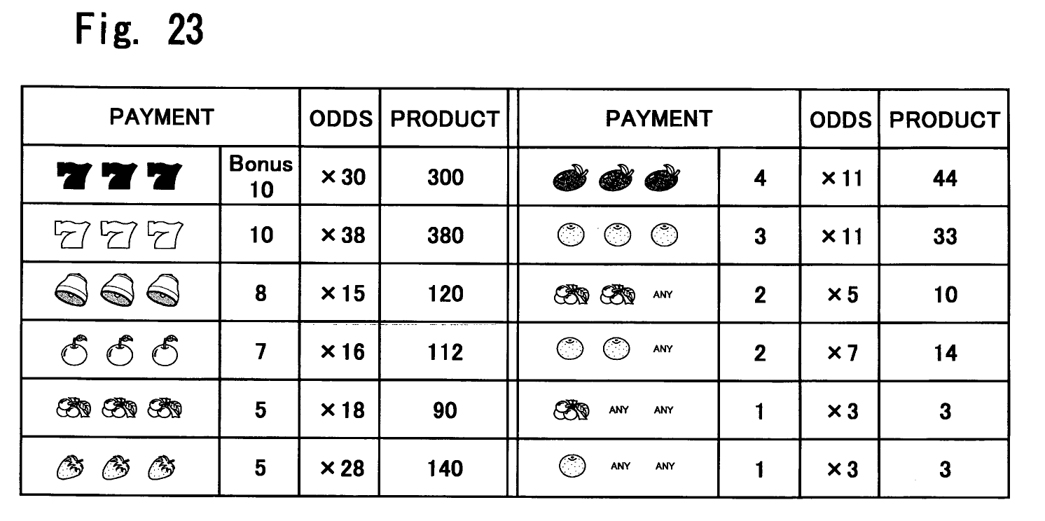

Further, as shown in FIG. 21, the current odds values vary as a result of winning or losing the game according to the respective winning probabilities of the winning combinations. More concrete examples are shown in FIGS. 22 and 23.

Since RED 7 has a low winning probability, the probability to win the RED 7 and to restore the odds value to the initial one is also low. Therefore, it is more likely for the odds value of the RED 7 to increase up to “116” as shown in FIG. 22 even thought the odds value is incremented by one than those of the other winning combinations. As shown in the figure, many payout amounts to be paid out as a result are not easy to calculate. Further, the timing of initializing the odds values are determined independently among the winning combinations so that it is possible to have a situation that the order of the odds numbers are not the same as that of the winning probabilities. For example, the odds values 15 and 22 of APPLE 3 and STRAWBERRY 3, respectively are in the reverse direction according to the order of the winning probabilities. Then, the product values thereof are 105 and 110, which is also in the reverse direction.

FIG. 23 shows an image having changed current odds values as the player has played more games. As shown in FIG. 22, it is not necessarily easy to calculate the payout amounts. And the reverse orders in the odds values and the payout amounts are also shown.

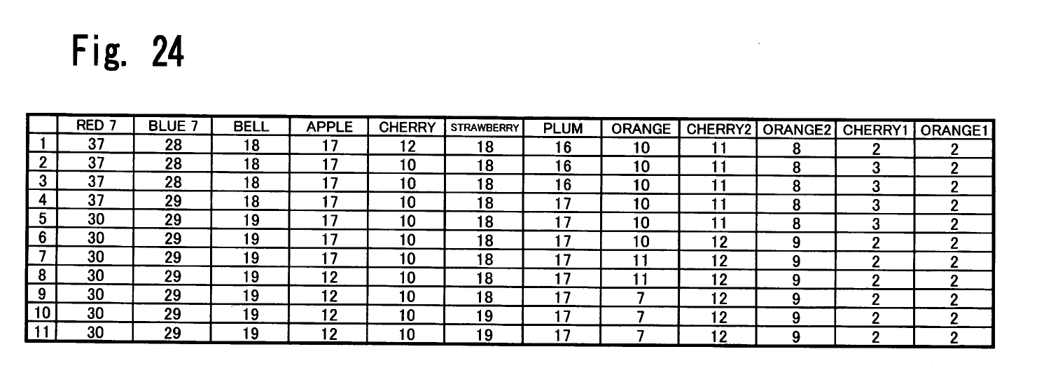

FIGS. 24 to 26 show the current odds values for the respective winning combinations for the consecutive games from one to 11 in three certain periods as the games are played continuously. In FIG. 24, RED 7 is won in the fourth round such that the odds number of “37” is restore to the initial value of “30” in the fifth round. And as to BLUE 7 winning combination, since the winning combination has not been won in the last 10 rounds such that the odds number is increased by one in the fourth round.

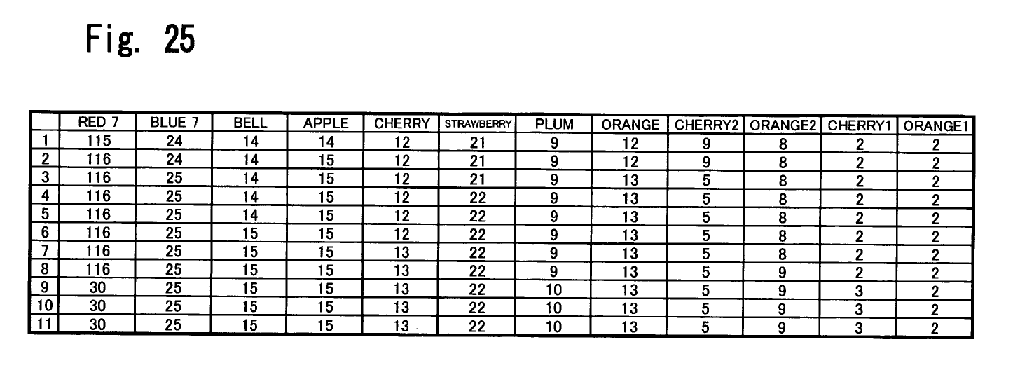

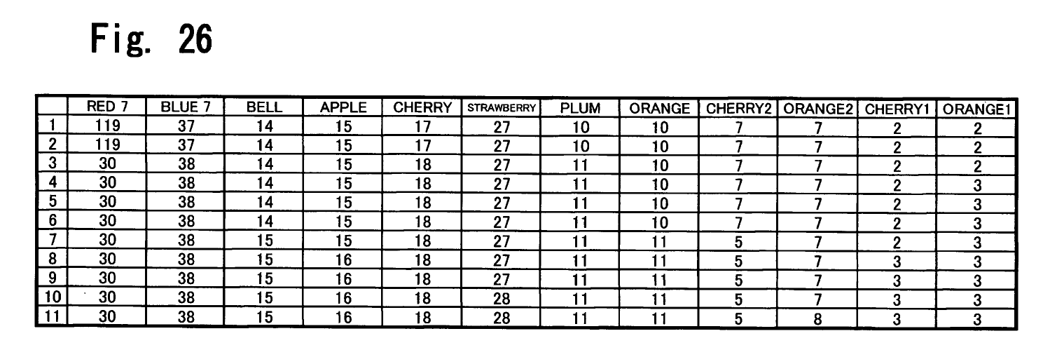

In FIG. 25, RED 7 winning combination is won in the eighth round, the odds number of “116” is returned to the initial value of “30” in the ninth round. Likewise in FIG. 26. Also, there are some cases where the order of winning probabilities and that of odds values are not in the same order.

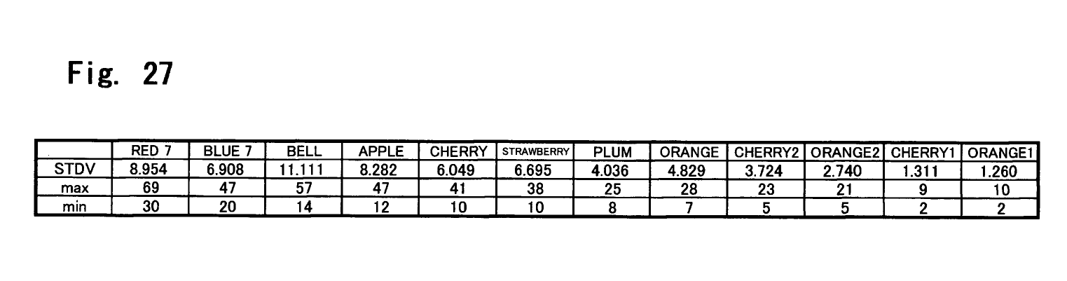

In FIG. 27, statistical data of odds values of respective winning combinations for a certain period of time are shown. The minimum values are to be the initial values and the maximum values are some values, which do not have any upper limits, but are according to the respective winning probabilities. As shown in the figure, the maximum values are not necessarily in the order of the winning probabilities, but tend to be in the order. The standard deviation values are also not necessarily in the order of the winning probabilities, but tend to be in the order.

In the aforementioned examples, the odds increments, i.e., the way of increasing the odds value, are uniform. However, these maximum values and standard values are recorded the day before and the odds increments may be adjusted in the next day. Also, even in the same day, the whole day is divided in half and the results in the morning session may be reflected on the afternoon session. Or these values having been obtained by now can be referred to and the odds increment for the next some rounds can be adjusted.

As described above, various embodiments and modified embodiments are explained, and in addition the following may be included in the scope of the present invention.

A gaming machine which can provide improved entertainment to the game player is provided since a new game which can provide a new and high payout amount.

A gaming machine (e.g., slot machine 1) comprising: base bet setting means (e.g., 1-BET button and MAX-BET button) for setting a bet number of a game medium provided for a game; display means (e.g., lower image display panel 6) for displaying a plurality of symbols; lottery means (e.g., main CPU 41, S15) for conducting a lottery under a predetermined probability information in order to display the plurality of symbols on the display means; game control means (e.g., main CPU 41, S4) for controlling the game to provide a payout amount corresponding to a predetermined winning combination among a plurality of winning combinations being composed of a plurality of symbols displayed on the display means based on a lottery result by the lottery means; odds setting means (e.g., main CPU 41, S21) for resetting odds for each of the predetermined winning combinations based on the probability information by increasing the odds according to a repetition number of games until any one of the predetermined winning combinations being composed of a plurality of symbols displayed on the display means; odds display means (e.g., upper image display panel 7) for displaying odds for each of the predetermined winning combinations, the odds being set by the odds setting means; and special bet means (e.g., ODDS-BET button 18) for betting a game medium for the odds set by the odds setting means is provided. Here, the game control means (e.g., a CPU 41, S4, S20) provides the payout amount corresponding to an obtained winning combination among the plurality of winning combinations of the plurality of symbols displayed on the display means when the game medium is bet by the special bet means and thus-selected winning combination matches the obtained winning combination in accordance with the bet number set by the base bet setting means and the odds set by the odds setting means.

The gaming machine (e.g., slot machine 1), as recited above, is characterized in that the odds display means (e.g., upper image display panel 7) displays odds set by the odds setting means (e.g., main CPU 41, S21) for each of the predetermined winning combinations after the game medium is bet by the special bet means (e.g., ODDS-BET button 18).

The gaming machine (e.g., slot machine 1), as recited above, is characterized in that the odds setting means (e.g., main CPU 41, S21, S205) initializes the odds corresponding to the obtained winning combination when the payout amount corresponding to the predetermined winning combination as any one of the plurality of predetermined winning combinations being composed of a plurality of symbols displayed on the display means (e.g., lower image display panel 6).

By way of example, the following may be included in the present invention.

Thus, the present invention may provide a gaming machine comprising: a base bet setting device for setting a bet number for a game; a display device for displaying a plurality of symbols; a special bet device for setting odds for a winning combination of symbols; an odds display device for displaying odds for a plurality of winning combinations, respectively; and a processor for controlling the game. The processor is operable to: calculate a payout amount by multiplying a payout rate with the bet number set by the base bet setting device when any one of the plurality of winning combinations of symbols is displayed; calculate a total payout amount by multiplying the payout amount with the odds set by the special bet device; and pay out the total payout amount.

The aforementioned gaming machine, on which a same kind of game is played repeatedly, may be provided with the processor, which is operable to: increment a game number by one for an individual winning combination when the individual winning combination in a previous game is not displayed; initialize the game number and the odds when the individual winning combination in a previous game is displayed; and increase the odds when the game number exceeds a threshold.

The aforementioned gaming machine, on which a same kind of game is played repeatedly, may be provided with the odds display device, which displays renewed game number and odds when the game is repeated.

The aforementioned gaming machine may be provided with the processor, which is operable to: display a product of the bet number and the odds as well as the corresponding winning combination.

The present invention may provide a gaming machine comprising: a base bet setting device for setting a bet number for a game; a display device for displaying a plurality of symbols; a special bet device for setting odds for a winning combination of symbols; an odds display device for displaying odds for a plurality of winning combinations, respectively; and a processor for controlling the game. The processor is operable to: conduct a lottery to select at least one of the plurality of winning combinations; calculate a payout amount by multiplying a payout rate with the bet number set by the base bet setting device when any one of the plurality of winning combinations is displayed based on a lottery result; calculate a total payout amount by multiplying the payout amount with the odds set by the special bet device when the winning combination is displayed; and pay out the total payout amount.

The aforementioned gaming machine may be provided with the odds display device which displays a product of corresponding odds and payout rate for each winning combination.

As mentioned above, the player can play the game with a base bet, in which a payout corresponding to an obtained predetermined winning combination, and a high payout game, in which the payout is magnified by the odds that increases as a repetition number of the game increases. Therefore, the player may have more interest toward the game.

What is claimed is:

1. A gaming machine comprising:
a base bet setting device for setting a bet number for a game;
a display device for displaying a plurality of symbols;
a special bet device for setting odds for a winning combination of symbols;
an odds display device for displaying the odds for a plurality of winning combinations, respectively; and
a processor for controlling the game,
wherein the processor is operable to:
calculate a payout amount by multiplying a payout rate with the bet number set by the base bet setting device when any one of the plurality of winning combinations of symbols is displayed;
calculate a total payout amount by multiplying the payout amount with the odds set by the special bet device; and
pay out the total payout amount.

2. The gaming machine, on which a same kind of game is played repeatedly, according to claim 1,
wherein the processor is operable to:
increment a game number by one for an individual winning combination when the individual winning combination in a previous game is not displayed;
initialize the game number and the odds when the individual winning combination in a previous game is displayed; and
increase the odds when the game number exceeds a threshold.

3. The gaming machine, on which a same kind of game is played repeatedly, according to claim 2,
wherein the odds display device displays renewed game number and odds when the game is repeated.

4. The gaming machine according to claim 3, wherein the processor is operable to:
display a product of the bet number and the odds as well as the corresponding winning combination.

5. The gaming machine according to claim 1 wherein the odds display device displays a product of corresponding odds and payout rate for each winning combination.

6. A gaming machine comprising:
a base bet setting device for setting a bet number for a game;
a display device for displaying a plurality of symbols;
a special bet device for setting odds for a winning combination of symbols;
an odds display device for displaying the odds for a plurality of winning combinations, respectively; and
a processor for controlling the game,
wherein the processor is operable to:
conduct a lottery to select at least one of the plurality of winning combinations;
calculate a payout amount by multiplying a payout rate with the bet number set by the base bet setting device when any one of the plurality of winning combinations is displayed based on a lottery result;
calculate a total payout amount by multiplying the payout amount with the odds set by the special bet device when the winning combination is displayed; and
pay out the total payout amount.

7. The gaming machine according to claim 6 wherein the odds display device displays a product of corresponding odds and payout rate for each winning combination.
